(19) United States
(12) Patent Application Publication
(10) Pub. No.: US 2012/0044085 A1
(43) Pub. Date: Feb. 23, 2012

(54) MULTIFUNCTIONAL DOORBELL WITH CONTROLLABLE LIGHTING

(75) Inventor: Law Bing Hung, Sheung Wan (HK)

(73) Assignee: WORLD ENTERPISE SINO LTD, SHEUNG WAN (HK)

(21) Appl. No.: 13/071,527

(22) Filed: Mar. 25, 2011

(30) Foreign Application Priority Data
Aug. 19, 2010 (HK) 10107941.3

(51) Int. Cl. G08B 7/00

(52) U.S. Cl. 340/815.69

(57) ABSTRACT

The present invention relates to a multifunctional doorbell with controllable lighting which comprises an outdoor member and an indoor member. The outdoor member and the indoor member communicate with each other by wireless signals. The indoor member comprises a power supply, a speaker, a light and sound control module and a lighting member. The light and sound control module is connected with the power supply. The lighting member and the speaker are both connected with the light and sound control panel. Based on the existing wireless doorbell system, the present multifunctional doorbell with controllable lighting could also alert occupants of a house to presence of visitors outdoor by way of lighting. Besides, the indoor member may be configured to switch on and off in response to ambient light conditions and thereby providing lighting at night.

### BACKGROUND OF THE INVENTION

The present invention relates generally to doorbell technology and more specifically relates to a multifunctional doorbell with controllable lighting.

Existing doorbells are generally wireless doorbells. Each of these doorbells comprises two members, namely an outdoor member and an indoor member. The outdoor member and the indoor member communicate with each other by wireless signals. When visitors outdoor press the outdoor member, the outdoor member will emit signals. The signals are then received by the indoor member and thereby activate a speaker to play songs or jingles to alert occupants indoor to the presence of visitors outdoor. These existing wireless doorbells are more convenient for use and also suitable for a wider application scope. However, they are deficient in certain aspects: the indoor member functions unitarily. It can only alert the presence of visitors by means of sounds and there are no other assisting means. If the occupants indoor suffer from hearing problem, they would feel inconvenient as they often fail to hear the bell and thereby fail to notice visitors outdoor. Besides, the indoor member has no other auxiliary functions (e.g. lighting) apart from emitting sounds. Use of the existing doorbells is therefore limited and fails to satisfy the diversified requirements for daily life.

### BRIEF SUMMARY OF THE INVENTION

In view of the aforesaid disadvantages now present in the prior art, the present invention provides a multifunctional doorbell with controllable lighting providing multiple functions and multiple controllable lighting effects. Its structure is also simple and reasonable.

The above objects are attained by the following technological proposal: a multifunctional doorbell with controllable lighting comprising an outdoor member and an indoor member communicating with each other by wireless signals. It is characterized in that the said indoor member comprises a power supply, a speaker, a light and sound control module and a lighting member. The said light and sound control module is connected with the said power supply. The said lighting member and the said speaker are simultaneously connected with the said light and sound control module.

The said lighting member is connected with a photosensitive component. The said lighting member and the said photosensitive component are simultaneously connected with a function selection switch.

The said photosensitive component is disposed at a position exposing to external lights, for instance, disposed to direct exposure to external lights or exposure to external lights via transparent glasses.

The said photosensitive component could be a photosensitive resistor.

The said lighting component could be a light-emitting diode (LED). Number of the said LED could be one or more, preferably two to four.

The said function selection switch is switchable among a continuous lighting position, a bell ring lighting position and a light-controlled lighting position. The three positions correspond respectively to the following three conditions: (1) provide continuous lighting, (2) provide lighting only when the outdoor member is activated, and (3) provide lighting automatically when there is insufficient light (controlled by the said photosensitive component).

The said light and sound control module could be an integrated circuit (IC) of model number KM995-68.

The said indoor member also comprises a song and jingle setting switch. The said song and jingle setting switch is simultaneously connected with the said light and sound control module for switching preset songs and jingles.

The said power supply could be an alternative current of 110V or 220V.

The operation principle of the present invention is described as follows: Based on the existing wireless doorbell system, lighting is also provided to alert occupants of a house to the presence of visitors outdoor. Besides, the indoor member could also be configured to switch on and off in response to ambient light conditions and thereby providing lighting at night.

As compared with the prior art, the present invention has the following advantages and benefits: (1) It could alert occupants indoor by means of both sound and light. Even if the occupants suffer from hearing problem, they could still notice the presence of visitors. The poor applicability of unitary sound alert could thereby be prevented. (2) Based on different needs, the present invention could be flexibly configured to different modes as follows: 1) provide continuous lighting, 2) provide lighting only when the outdoor member is activated, or 3) provide lighting automatically when there is insufficient light. Therefore, the present invention could function not only as a doorbell, but also as a source of lighting for use in many conditions. It is especially suitable for use as a small night light to provide soft light so that eyes discomfort could be prevented. It also saves energy to satisfy the need for environmental protection.

### BRIEF DESCRIPTION OF THE DRAWINGS

FIG. 1 is the front view of the outdoor member of the multifunctional doorbell with controllable lighting according to the present invention.

FIG. 2 is the front view of the indoor member of the multifunctional doorbell with controllable lighting according to the present invention.

FIG. 3 is the side view of the indoor member of the multifunctional doorbell with controllable lighting according to the present invention.

FIG. 4 is the circuit diagram of the indoor member of the multifunctional doorbell with controllable lighting as shown in FIG. 2 and FIG. 3.

### DETAILED DESCRIPTION OF THE INVENTION

The present invention is further explained in the following embodiment with reference to the accompanying drawings, but the embodiment of the present invention should not be limited to the following description.

### Embodiment 1

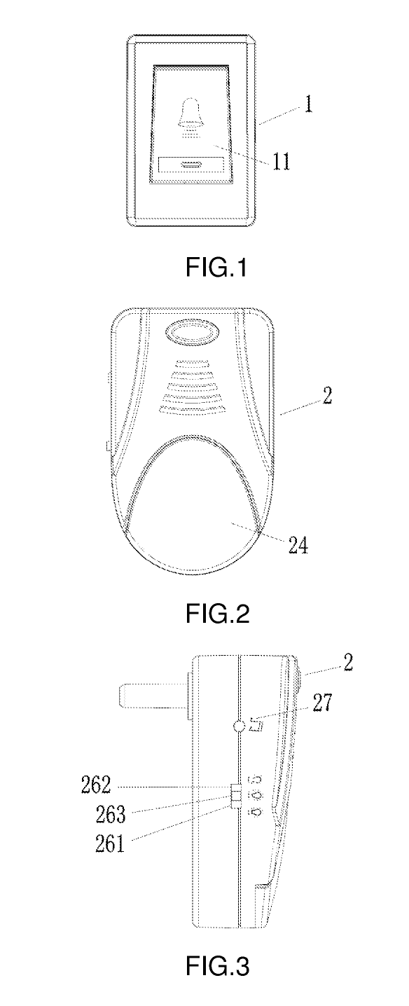

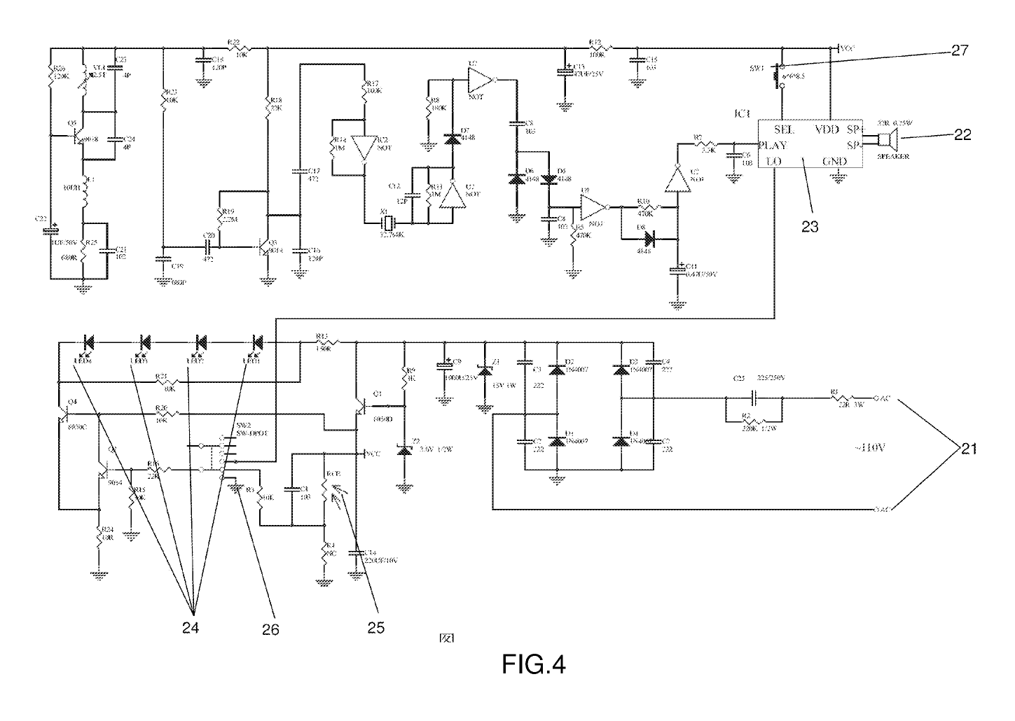

FIG. 1 to FIG. 4 illustrate a detailed structure of the present invention. The multifunctional doorbell with controllable lighting according to the present invention comprises an outdoor member 1 and an indoor member 2 communicating with each other by wireless signals. As shown in FIG. 4, the circuit of the said indoor member 2 comprises a power supply 21, a speaker 22, a light and sound control module 23 and a lighting member 24. The said light and sound control module 23 is connected with the said power supply 21. The said lighting member 24 and the said speaker 22 are simultaneously connected with the said light and sound control module 23. The said lighting member 24 is connected with a photosensitive component 25. The said lighting member 24 and the said photosensitive component 25 are simultaneously connected with a function selection switch 26. The said photosensitive component 25 is a photosensitive resistor. The said lighting member 24 comprises four light-emitting diodes (LED). The said photosensitive component 25 is disposed at a position exposing to external lights, for instance, disposed to direct exposure to external lights or exposure to external lights via transparent glasses.

As shown in FIG. 3, the said function selection switch 26 is disposed on one side of the said indoor member 2. It is switchable among a continuous lighting position 261, a bell ring lighting position 262 and a light-controlled lighting position 263. The three positions correspond respectively to the following three conditions: (1) provide continuous lighting, (2) provide lighting only when the outdoor member is activated, and (3) provide lighting automatically when there is insufficient light (controlled by the said photosensitive component).

The said indoor member 2 also comprises a song and jingle setting switch 27. The said song and jingle setting switch 27 is simultaneously connected with the said light and sound control module 23 for switching preset songs and jingles.

The said light and sound control module 23 could be an integrated circuit (IC) of model number KM995-68. The said power supply 21 is an alternative current of 110V. In this embodiment, the said indoor member 2 is integrally disposed with a power plug which can be directly inserted into a power socket on a wall.

The mechanism of the present invention is described as follows: When a bell key 11 of the said outdoor member 1 is pressed, the said outdoor member 1 will emit signals. The signals emitted from the said outdoor member 1 will then be received by the indoor member 2 which will then transmit the signals to the said light and sound control module 23 of the said indoor member 2. When the said light and sound control module 23 of the said indoor member 2 receives the signals, it will activate the said speaker 22 of the indoor member 2 to play the preset songs or jingles of the doorbell. Besides, when the said function selection switch 26 is switched to position (2) to provide lighting only when the outdoor member is activated, the said light and sound control module 23 of the indoor member 2 will activate lighting of the said lighting member 24. When the said function selection switch 26 is switched to position (3) to provide lighting automatically when there is insufficient light, brightness of the said lighting member 24 will be controlled by the said photosensitive component 25 so that it grows gradually stronger when the ambient light level is lower. When the said function selection switch 26 is switched to position (1) to provide continuous lighting, the said lighting member 24 and the said power supply 22 will stay connected and provide continuous lighting. When the said song and jingle setting switch 27 is pressed, the said light and sound control module 23 of the said indoor member 2 will switch the preset songs or jingles.

The above embodiment is the preferred embodiment of the present invention, but the embodiment of the present invention should not be limited to the above description. Any other changes, modifications, substitutions, combinations and simplification that do not diverge from the spiritual essence and principle of the present invention are equivalent alternative configurations and should fall into the scope of protection of the present invention.

What is claimed is:

1. A multifunctional doorbell with controllable lighting comprising an outdoor member and an indoor member communicating with each other by wireless signals, characterized in that: the said indoor member comprises a power supply, a speaker, a light and sound control module and a lighting member; the said light and sound control module is connected with the said power supply; the said lighting member and the said speaker are simultaneously connected with the said light and sound control module.

2. A multifunctional doorbell with controllable lighting as in claim 1, characterized in that the said lighting member is connected with a photosensitive component; the said lighting member and the said photosensitive component are simultaneously connected with a function selection switch.

3. A multifunctional doorbell with controllable lighting as in claim 2, characterized in that the said photosensitive component is disposed at a position exposing to external lights.

4. A multifunctional doorbell with controllable lighting as in claim 3, characterized in that the said photosensitive component is disposed to expose directly to external lights or expose to external lights via transparent glasses.

5. A multifunctional doorbell with controllable lighting as in claim 2, characterized in that the said photosensitive component is a photosensitive resistor.

6. A multifunctional doorbell with controllable lighting as in claim 1, characterized in that the said lighting member is a light-emitting diode.

7. A multifunctional doorbell with controllable lighting as in claim 6, characterized in that the number of light-emitting diodes is between two to four.

8. A multifunctional doorbell with controllable lighting as in claim 2, characterized in that the said function selection switch is switchable among a continuous lighting position, a bell ring lighting position and a light-controlled lighting position.

9. A multifunctional doorbell with controllable lighting as in claim 1, characterized in that the said indoor member comprises a song and jingle setting switch; the said song and jingle setting switch is simultaneously connected with the said light and sound control module.

10. A multifunctional doorbell with controllable lighting as in claim 1, characterized in that the said power supply is an alternative current of 110V or 220V.
